(19) United States
(12) Patent Application Publication
(10) Pub. No.: US 2026/0370904 A1
(43) Pub. Date: Nov. 19, 2026

(54) MODULATION OF NETWORK ACTIVITY TO OPTIMISE THE PLAYBACK OF A MEDIA STREAM

(71) Applicant: SAGEMCOM BROADBAND SAS, Bois-Colombes (FR)

(72) Inventors: Clément PARISOT, Bois-Colombes (FR); Arthur JARDIN, Bois-Colombes (FR)

(21) Appl. No.: 19/681,971

(22) Filed: May 19, 2026

(30) Foreign Application Priority Data
May 19, 2025 (FR) FR2505333

(51) Int. Cl. H04N 21/4363; H04N 21/233

(52) U.S. Cl. CPC H04N 21/43637; H04N 21/233

(57) ABSTRACT

A communication device comprising: a radio communication interface comprising a first module using a communication channel within a first wireless network, and a second module using said communication channel within a second wireless network comprising at least one piece of playback equipment; a processing unit arranged to determine, at a time t, whether the second module will transmit within a predetermined time following time t a media stream to said at least one piece of playback equipment of the second wireless network so that said at least one piece of playback equipment plays back said media stream and, if so, to implement at least one limiting action allowing to limit an occupation of the communication channel by the first module.

### DESCRIPTION

The invention relates to the field of equipment using the same radio communication interface to communicate in a first wireless network and in a second wireless network, the second wireless network comprising one or more pieces of equipment playing back a media stream transmitted by said radio communication interface.

### BACKGROUND OF THE INVENTION

A decoder box, also called a TV decoder, audiovisual decoder or STB for Set-Top Box, is conventionally intended to receive an audio-video stream, to decode it and to process it, to separate the audio stream and the video stream, to transmit the video stream to a television, and to transmit the audio stream to one or more audio devices.

The audio-video stream can come from any source, which is, for example, a broadcasting network (satellite television network, internet connection, digital terrestrial TV (DTTV) network, cable television network, etc.), another piece of equipment connected to the set-top box(a CD, DVD or BlueRay player, a smartphone, a tablet, etc.), or also a storage medium (and, for example, a USB stick or a memory card connected to the set-top box).

The audio device(s) may comprise the television audio device, a sound bar, satellite speakers, or possibly, in the case of an “advanced” set-top box, an audio device internal to the set-top box.

Among the features implemented by such a set-top box, there are the following in particular:
wireless internet connectivity, allowing connection to a home gateway. The gateway is intended to interconnect a local area network (LAN) to a wide area network (WAN). The local area network is, for example, a Wi-Fi network. This connectivity allows the set-top box to receive audio-video streams of streaming services. To ensure the speed of the user interface and the high quality of video streams, the Wi-Fi connection must allow very high throughputs. The set-top box can perform scans of the radio environment regularly and without user intervention, for example to optimise the Wi-Fi connection to the gateway. Scans allow to detect surrounding networks and thus automatically connect to the best available network, e.g. as part of roaming functions.
playback of the audio stream, associated with the audio-video stream, on wireless satellite speakers, so as to playback the audio in a multi-channel format, often called surround, such as the 5.1 format. In order to ensure synchronisation between the video stream and the audio stream, the transmission of the audio data by the set-top box to the satellite speakers, via wireless communication, must have a very low latency.

These features should disrupt each other as little as possible while acting simultaneously.

With reference to FIG. 1, two wireless networks are therefore implemented in a system comprising a set-top box 1, a gateway 2 and one or more satellite speakers 3: a primary network 4 and a secondary network 5.

The gateway 2 comprises a so-called “primary” access point 6 to which the station 7 of the set-top box 1 is connected, in order to define the primary network 4. The set-top box 1 is therefore connected to the primary access point 6 of the gateway 2, for example in order to access the Internet. The set-top box 1 also comprises a so-called “secondary” access point 8 to which the stations 9 of the satellite speakers 3 are connected, so as to define the secondary network 5. The audio stream Fa from the audio source 10 is transmitted by the set-top box 1 to the satellite speakers 3 via the secondary network 5. The video stream Fv is transmitted to a television 11.

We are interested in the case where the set-top box 1 comprises a single radio communication interface 12 for implementing the station 7 and the secondary access point 8.

Certain activities of the station 7, such as Wi-Fi scanning or transmitting (i.e. transmitting or receiving) data at very high speed, use all the resources of the radio communication interface 12, and may therefore disrupt the access point 8.

These disruptions are manifested by cuts in the audio stream Fa played back by the speakers 3, which is detrimental to the user experience.

It should be noted that the relevant prior art is very limited, since there are very few products that have the following constraints:
a single radio communication interface 12 for its station 7 (Wi-Fi for example) and for the connection (Wi-Fi for example) with the satellite speakers 3 (or other playback equipment), the activity of the station 7 being particularly conducive to disrupting the activity of the secondary access point 8 and therefore the user experience;
a need for spontaneous activity on the station 7 (e.g. scans for the roaming function) that may disrupt the connection with the speakers 3. This need for spontaneous activity does not respond to the action of a user, and therefore is not a reaction to a problem that could justify and make acceptable a disruption to the user.

There are several solutions implemented in the prior art to minimise the audio cuts of satellite speakers.

A first solution is to increase the reliability/robustness of the data string. This generally requires increasing the latency of the data string (which allows the necessary time to make retransmissions). However, the system may be forced to adhere to a very low latency in order to ensure synchronisation between video and audio.

A second solution consists in using a radio channel dedicated to satellite speakers, which can be done in several ways:
addition of a radio channel in the set-top box, which requires excessively increasing the size of the equipment to place the additional antennas with sufficient distance between antennas to avoid interference, and increasing the complexity of the Wi-Fi software module to be able to manage two radios;
addition of an external wireless transmitter device (such as soundsend or enclave cinehome, registered trademarks), which excessively increases the cost of manufacturing the system, and increases its complexity. By way of example, a second power supply cable may be required. It is also necessary to ensure compatibility between the set-top box and the transmitter device.

A third solution consists in using the gateway (see for example the DTS Play-Fi system, registered trademark), which requires that it be available in the network. However, the system is intended to be autonomous and therefore must also be able to operate without the presence of a Wi-Fi access point external to the set-top box (which can be the case, for example, when the set-top box is connected to Ethernet).

### AIM

The invention aims, in equipment using the same radio communication interface to communicate in a first wireless network and in a second wireless network, the second wireless network comprising one or more pieces of equipment playing back a media stream transmitted by said radio communication interface, to improve the quality and reliability of the transmission of the media stream, without presenting the disadvantages of the three solutions that have just been described.

### SUMMARY

In view of achieving this aim, a communication device is proposed, comprising:
a radio communication interface comprising a first module arranged to use a communication channel within a first wireless network, and a second module arranged to use said communication channel within a second wireless network comprising at least one piece of playback equipment;
a processing unit arranged to determine, at a time t, whether the second module will transmit within a predetermined time following time t a media stream to said at least one piece of playback equipment of the second wireless network via said communication channel so that said at least one piece of playback equipment plays back said media stream and, if so, to implement at least one limiting action allowing to limit an occupation of said communication channel by the first module.

Thus, when the processing unit detects that the second module is about to transmit a media stream (for example an audio stream) to the playback equipment (for example satellite speakers), it limits the occupation by the first module of the common communication channel. The transmission of the media stream is therefore no longer interrupted and the user experience is clearly improved. This solution only requires the implementation of an additional software module in the communication device and is therefore simple to implement and inexpensive. In particular, it does not require increasing the latency of the audio channel, adding a radio channel or a transmitting device, or using the gateway. The communication device thus allows to overcome the limitations of the prior art.

In addition, a communication device as previously described is proposed, in which the media stream is an audio stream.

In addition, a communication device such as described above is proposed, in which said at least one limiting action comprises an action consisting, following receipt of a scan request issued by an entity of an equipment integrating the communication device, in determining whether or not the scan associated with said scan request is necessary for a connection of the first module to the first wireless network, and in blocking or deferring the implementation of the scan only if the scan is not necessary for said connection.

In addition, a communication device such as described above is proposed, in which the processing unit is arranged to determine whether or not the scan is necessary based on an identifier of said entity.

In addition, a communication device such as described above is proposed, in which said at least one limiting action comprises an action consisting in blocking or deferring the implementation of at least one function not necessary for a connection of the first module to the first wireless network.

In addition, a communication device such as described above is proposed, in which the predetermined time has a duration greater than or equal to a duration of performance of said scan or of said at least one function.

In addition, a communication device such as described above is proposed, in which said at least one limiting action comprises an action consisting in limiting a speed of communication implemented by the first module.

In addition, a communication device such as described above is proposed, in which the predetermined time following the time t is a timeslot of predefined duration, and in which the processing unit detects that the second module will not transmit a media stream to said at least one piece of playback equipment in said timeslot following the time t when the second module has not transmitted a media stream to said at least one piece of playback equipment for a predetermined number of timeslots preceding the time t.

In addition, a communication device such as described above is proposed, in which the first module is a Wi-Fi station, and the second module is a Wi-Fi access point.

In addition, a set-top box is proposed, integrating a communication device as previously described.

In addition, a communication method is proposed, implemented in the processing unit of a communication device as described above, and comprising the steps of determining, at a time t, whether the second module will transmit within a predetermined time following the time t a media stream to said at least one piece of playback equipment of the second wireless network via the communication channel so that said at least one piece of playback equipment plays back said media stream and, if so, implementing at least one limiting action allowing to limit an occupation of the communication channel by the first module.

In addition, a computer program is proposed, comprising instructions that cause the communication device as described above to execute the steps of the communication method as described above.

In addition, a computer-readable storage medium is proposed, on which the computer program as described above is stored.

The invention will be best understood, in the light of the description below of particular, non-limiting embodiments of the invention.

### BRIEF DESCRIPTION OF THE DRAWINGS

Reference will be made to the accompanying drawings, among which:

FIG. 1 shows a gateway, a prior art set-top box, a television and a satellite speaker;

FIG. FIG. 2 shows a gateway, a set-top box, a television and two satellite speakers; and

FIG. 3 illustrates a communication method according to a first embodiment;

FIG. 4 is a diagram comprising the steps of the scan filtering method according to the Wi-Fi station;

FIG. 5 illustrates the communication method according to a second embodiment and a third embodiment;

FIG. 6 is a diagram comprising the steps of the rate limiting method and the method of deactivating the optional functions.

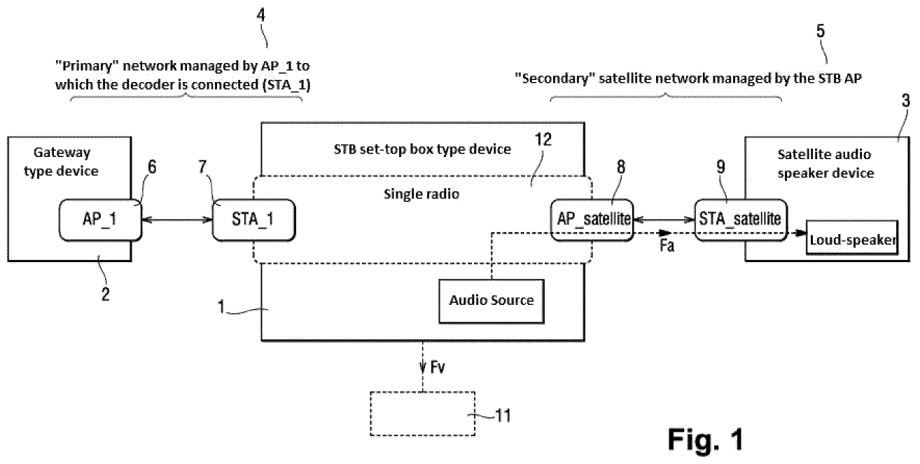

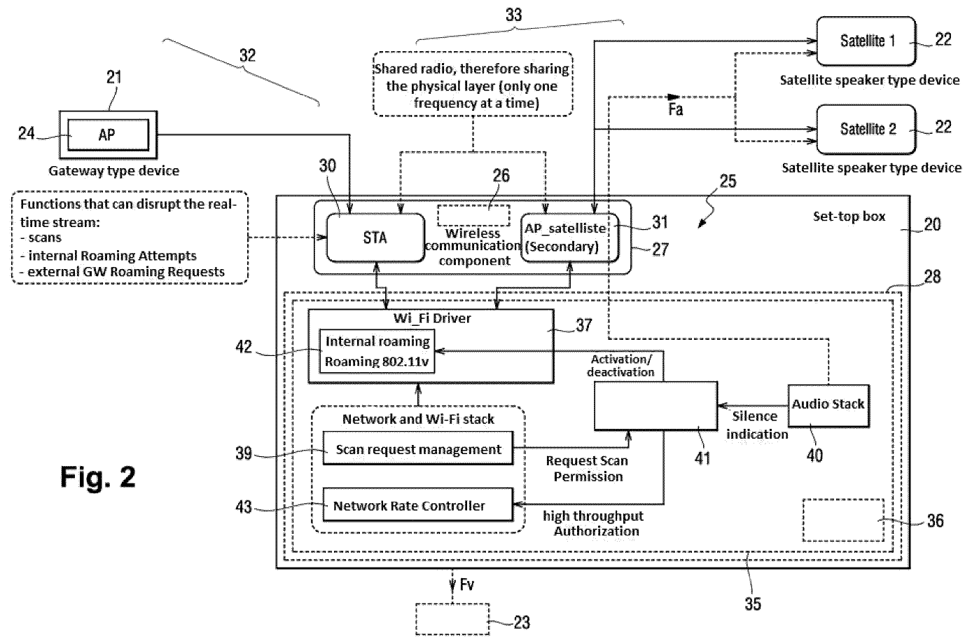

### DETAILED DESCRIPTION

In reference to FIG. 2, the set-top box 20 is connected to a home gateway 21, satellite speakers 22, and a television 23.

The set-top box 20 is in particular intended to broadcast an audio-video stream, and for this purpose transmits the video stream Fv to the television 23 and the audio stream Fa to the speakers 22. In order to ensure synchronisation between the sound of the audio stream Fa and the images of the video stream Fv, the audio data channel to the satellite speakers 22 has a very low latency (typically less than 50 ms).

The home gateway 21 comprises a primary access point 24.

The set-top box 20 comprises firstly a communication device 25 comprising a single radio communication interface 27 and a processing unit 28.

In this case, the radio communication interface 27 is integrated into a single wireless communication component. The radio communication interface 27 comprises or is connected to a single set of one or more antennas 26. For example, several antennas are used according to MIMO (Multiple Input Multiple Output) technology. The single set of one or more antennas 26 is dedicated to the implementation of the physical layer of the radio communication interface 27. The radio communication interface 27 comprises a first module 30, specifically a station, and a second module 31, in this case a secondary access point. The first module 30 and the second module 31 are hardware and/or software modules.

The station 30 uses a communication channel within a first wireless network 32. The first wireless network 32 comprises the gateway 21 and the set-top box 20. The primary access point 24 of the gateway 21 and the station 30 of the set-top box 20 therefore define a primary network 32, which in this case is a Wi-Fi network.

The secondary access point 31 uses the same communication channel within a second wireless network 33 comprising the set-top box 20 and one or more pieces of playback equipment, which in this case are the speakers 22. The secondary access point 31 of the set-top box 20 and the speakers 22 therefore define a secondary network 33, which in this case is also a Wi-Fi network.

The communication channel uses the single set of antennas 26 previously mentioned.

The set-top box 20 transmits a media stream to the speakers 22 via the secondary network 33. In this example, the media stream is the audio stream Fa. This is, for example, a 360° multi-channel sound.

The set-top box 20 therefore has a Wi-Fi station 30:
which shares the radio communication interface 27 with the secondary access point 31 used for the satellite speakers 22; and
which is connected to the Wi-Fi home gateway 21; and
the connection of which, is used for Internet access.

The processing unit 28 of the communication device 25 is a software and hardware unit. The processing unit 28 comprises at least one processing component 35, which is for example, a “general purpose” processor, a processor specialised in signal processing (or DSP, for Digital Signal Processor), a processor specialised for artificial intelligence algorithms (NPU-type, for Neural Processing Unit), a microcontroller, or a programmable logic circuit such as a FPGA (for Field Programmable Gate Arrays) or an ASIC (for Application Specific Integrated Circuit).

The processing unit 28 also comprises one or more memories 36, connected to or integrated into one or more processing components. At least one of these memories 36 forms a computer-readable storage medium, on which is stored at least one computer program comprising instructions that cause the processing unit 28 to execute the steps of the communication method that will be described.

The processing unit 28 here comprises a Wi-Fi driver 37, which implements the Wi-Fi protocol, including certain optional functionalities 42, such as the BSS Transition (often called steering) according to the IEEE 802.11v standard or the internal roaming. The processing unit 28 also comprises a set of software modules managing the use of the Wi-Fi driver 37 by the software of the processing unit 28, called here “Wi-Fi stack” 39, and a subset, within the operating system of the set-top box 20, implementing IP and TCP communication with other devices, referred to herein as “network stack” 43.

The processing unit 28 further comprises a set of software and hardware modules that manage the processing of the audio streams, referred to herein as the “audio stack” 40.

The processing unit 28 further comprises a processing module 41, which in this case is a purely software module.

The station 30 and the secondary access point 31 of the radio communication interface 27 use, as has been seen, the same communication channel. The station 30 and the secondary access point 31 share the radio communication interface 27 and therefore the physical layer. Only one frequency can be used at a time for these two modules 30, 31.

It should be noted that the radio communication interface 27 may be a single-band interface, but also be a dual-band (or more generally multi-band) interface, in which the station 30 and the secondary access point 31 both have activity on at least one common frequency band. For example, the station 30 may use a first frequency band to communicate within the first wireless network 32 (for example close to 2 GHz), while the secondary access point 31 uses a second frequency band to communicate within the second wireless network 33 (for example close to 5 GHz). In this case, although each module communicates mainly on a different band, the station 30 can still access the second frequency band (for scans for example) and disrupt the communications of the secondary access point 31. In such a case, the common communication channel is considered to comprise the second frequency band.

The processing module 41 will determine, at a time t, whether the access point 31 will transmit, within a predetermined time following the time t, an audio stream Fa to the speakers 22, via the communication channel, so that the latter playback said audio stream Fa and, if so, will implement at least one limiting action allowing to limit an occupation of the communication channel by the station 30.

The audio stream Fa in question is therefore a stream “intended to be played back”. If the access point 31 transmits data in audio format to the speakers 22, which contain silence, i.e. audio data associated with a zero sound signal, the processing module 41 considers that no audio stream is sent to the speakers 22 to be played back by the speakers 22, and therefore that it is not necessary to implement a limiting action.

By way of example, the predetermined time after time t is a timeslot of predefined duration. The processing module 41 here detects that the secondary access point 31 will not transmit an audio stream to the speakers 22 in the timeslot following the time t when the secondary access point 31 has not transmitted an audio stream to the speakers 22 for a predetermined number of timeslots preceding the time t.

When the speakers 22 connected to the secondary access point 31 of the set-top box 20 emit sound and it is expected that they will continue to do so in the near future, the processing unit 28 therefore causes the set-top box 20 to restrict certain Wi-Fi activities that could disrupt the Wi-Fi connection with the speakers 22. In other words, the processing module 41 allows the disturbing activities on the set-top box 20, without limitation, only when the satellite speakers 22 of the set-top box 20 are silent (i.e. the speakers 22 do not emit sound) and will remain silent during the predetermined time. Thus, at the time t, if the speakers 22 have not emitted sound for several timeslots preceding the time t, the processing module 41 considers that it will be the same for the next timeslot, so that the processing module 41 authorises for this next timeslot the unrestricted performance of said disruptive activities.

In a first embodiment, the at least one limiting action comprises an action consisting, following receipt of a scan request emitted by an entity of the set-top box 20, in determining whether or not the scan associated with said scan request is necessary for a connection of the station 30 to the first wireless network 32, and in blocking or deferring the implementation of the scan only if the scan is not necessary for said connection. The processing unit 28 will therefore analyse and filter certain scan requests. When the speakers 22 are about to emit sound, only unnecessary scan requests are blocked or deferred.

The scan function may be required to carry out a roaming application (which can be translated as “roaming”): e.g. internal roaming, roaming according to the IEEE 802.11v standard.

It is known that scan requests using the radio communication interface 27 of the set-top box 20, which is used by the station 30, on the one hand, and by the secondary access point 31 for the satellite speakers 22, on the other hand, can be made for various reasons, without user intervention.

For example, the station 30 of the set-top box 20 may be connected to several primary access points provided by one or more Wi-Fi home gateways, and may change, without user intervention, the access point in order to switch to the best available access point at the given time.

To do this, processes within the set-top box 20, such as internal roaming, periodically request scans, and analyse the results in order to determine the best available access point and to connect to it if it is not already the case. Depending on the state of the connection of the station 30 of the set-top box 20, these scan requests may be considered superfluous. Specifically, if the Wi-Fi connection is already of sufficient quality (that is to say that all the parameters of the connection, such as the RSSI (Received Signal Strength Indicator), the negotiated modulations, the frame retransmission rate, allow sufficient speeds and latencies to meet all the needs of the set-top box 20 including ensuring audio quality), there is no advantage to be gained by trying to connect to another gateway to improve the connection. Furthermore, such a scan may be deferred. Indeed, if the scan is carried out and if the results are provided later, this does not hinder the proper functioning of the internal roaming.

These scan requests may also aim to connect the station 30 to an access point after a loss of Internet connectivity. Performing the scan associated with this scan request is then considered essential: the scan is necessary to ensure proper reception of the video streams from the set-top box 20.

These scan requests may also aim to implement geolocation, by comparing the access points detected by the scan with a database of access points with a known position. Such a scan request is considered superfluous, as the main features of the set-top box 20 do not depend on it.

The processing module 41 therefore distinguishes between two types of scan request: the scan request necessary for the connection of the station 30 to the primary network 32, and the scan request not necessary for said connection.

Thus, when the processing unit 28 receives a scan request from an entity of the set-top box 20, the processing module 41 determines whether or not the scan associated with said scan request is necessary for the connection of the station 30 to the primary network 32, and blocks or defers the implementation of the scan only if the scan is not necessary for said connection.

Indeed, the implementation of a scan function requires strongly slowing down any data transmission on the radio communication interface 27 for a duration typically equal to about two seconds (including total cuts of the order of 100 ms). The set-top box 20 cannot therefore send audio data to the satellite speakers 22, which will have to cut off the audio playback for the duration of the scan (or at least playback the audio in a hashed and distorted manner because of the inevitable latency peaks).

The scan requests can be sent by different entities of the operating system of the set-top box 20, and each contain an identifier of the entity sending the request. It is therefore possible to infer the reason for the scan, for example by comparing the identifier in the request to a list of known identifiers for each scan reason. The processing module 41 therefore determines whether or not the scan request is necessary based on an identifier of said entity.

As has been seen, at time t, the processing module 41 implements the limiting action, allowing to limit an occupation of the communication channel by the station 30, only if the secondary access point 31 will transmit a media stream to the speakers 22 within a predetermined time following time t.

Advantageously, the predetermined time has a duration close to but greater than (or equal to) a duration of performance of the scan.

The duration of performance of the scan is therefore equal to a duration D, and the following applies:

d≥D,

where d is the predetermined time.

The predetermined time is therefore here slightly greater than 2 s.

Indeed, it is not necessary to block or defer the implementation of a function, even if not necessary, if the processing module 41 determines that no sound will be emitted before the end of the performance of this function.

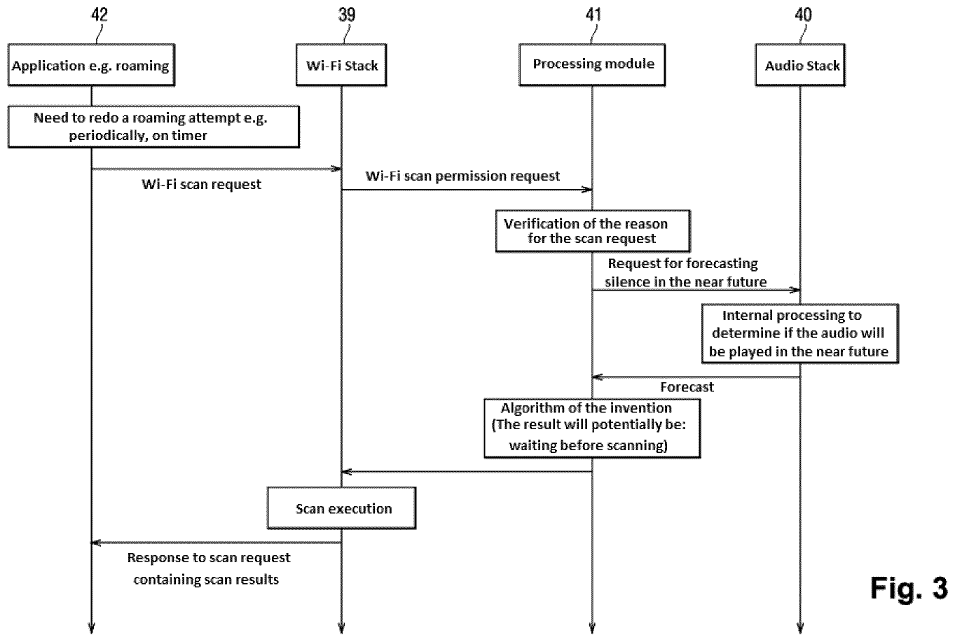

With reference to FIG. 3, the communication method according to the first embodiment is described in more detail.

The limiting action consists in blocking or deferring the implementation of the scan that results from a scan request from an entity internal to the set-top box 20.

The Wi-Fi stack 39 of the processing unit 28 of the set-top box 20 therefore receives a scan request from one of several software that can make such a request, in this case from the roaming application 44.

At time t, the processing module 41 receives the scan authorisation request from the Wi-Fi stack 39 and verifies the reason for the scan request.

Then, the processing module 41 interrogates the audio stack 40 to find out whether the secondary access point 31 will transmit an audio stream to the speakers 22 within the predetermined time following the time t.

The audio stack 40 implements internal processing to determine whether audio will be played in the near future (i.e. same order of magnitude as the scan duration, or approximately 2 seconds).

The audio stack 40 checks for this if the speakers 22 have emitted sound on several previous timeslots, and estimates that the same will be true for a next timeslot. Alternatively, the audio stack 40 may detect that the next n seconds of audio in the buffer (i.e., the duration of the predetermined time) are silent, i.e., no audio stream is sent to the speakers 22 for playback.

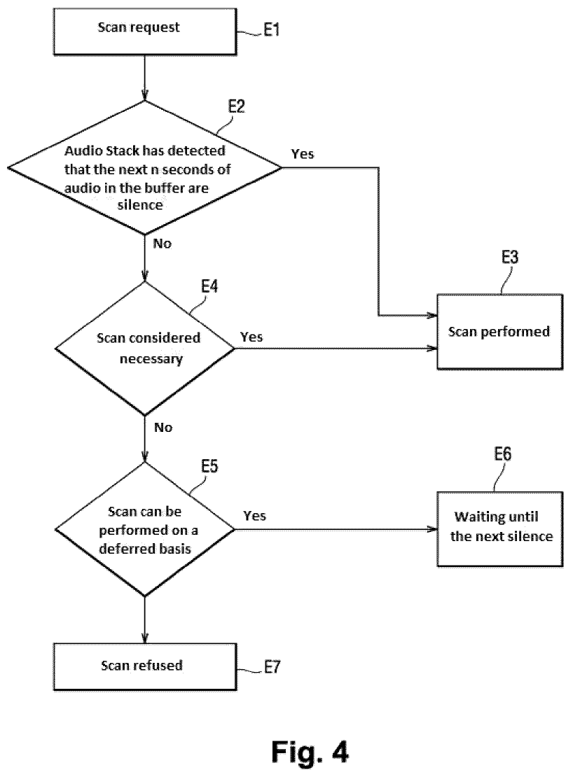

The processing module 41 then receives the prediction from the audio stack 40, and implements the algorithm of FIG. 4.

Following the scan request (step E1), the processing module 41 checks that the audio stack 40 has indeed detected that no audio stream is about to be sent to the speakers 22 to be played back: step E2.

If this is the case, a software module, implemented in the processing module 41, and hereinafter referred to as the “request filter”, instructs the Wi-Fi stack 39 to execute the scan immediately: step E3. The scan will therefore take place and will be likely to disrupt the (potential) transmission of data to the speakers 22, but this will not result in an audible interruption because the speakers 22 do not emit sound at this time.

If this is not the case, that is to say if an audio stream is going to be played back within the predetermined time, the request filter determines whether the scan associated with the scan request is considered necessary to allow the connection of the station 30 to the network 32: step E4.

For this, as has been seen, the request filter studies, for example, the identifier of the source entity of the request in order to infer the reasons for the scan. Depending on the reason, the request filter determines whether the scan request is necessary or not.

If the scan is necessary, the request filter instructs the Wi-Fi stack 39 to execute the scan immediately: step E3.

If the scan is not necessary, the request filter checks if the scan can be deferred (step E5).

If this is the case, the request filter instructs the Wi-Fi stack 39 to put the scan request on hold (step E6). The scan will be executed when the audio stack 40 has determined that the speakers 22 will not emit sound in the near future.

If the scan cannot be deferred, the request filter instructs the Wi-Fi stack 39 to refuse the scan (step E7).

Returning to FIG. 3, the Wi-Fi stack 39 therefore either executed the scan or did not execute it. The Wi-Fi stack 39 therefore transmits the response to the scan request to the entity making the request, said response possibly containing the scan results.

In this example, where the potentially disruptive function is a scan of the Wi-Fi channels, the processing unit 28 therefore identifies the reason for the scan request and according to the reason:
authorises the scan because it is necessary;
refuses the scan because it is not necessary; or
puts the request on hold, to be processed as soon as the processing module 41 detects that no sound will be emitted by the speakers in the near future (i.e. indication of silence received from the audio stack 40).

Thus, at the end of these steps, the requests for superfluous scans cannot cause audible cuts to the audio emitted by the satellite speakers 22.

In a second embodiment, said at least one limiting action, implemented by the processing unit 28 when the speakers 22 are about to playback sound, comprises an action consisting in limiting the speed of the communication implemented by the station 30.

The set-top box 20 is capable of making large data transfers (typically greater than 100 MB), at high speed (typically greater than 500 Mbps) to or from the Internet, through the connection of its Wi-Fi station 30. For example, the set-top box 20 may download high-quality video streams or software updates from the Internet, or upload its tracks, bug reports, and usage statistics to the Internet. These data transfers are not inherently constrained, and they can therefore use all the bandwidth made available by the radio communication interface 27. In this case, there may be no more bandwidth available for the access point 31 of the satellite speakers 22. In the same manner as for scans, this may result in audio cuts to the satellite speakers 22.

Several implementations can be envisaged in order to limit the rate received by the set-top box 20 through its Wi-Fi station 30.

One possible implementation is the use of qdisc (queue disciplines, doc: tc), a subsystem of the network stack of the Linux kernel (registered trademark). Qdisc allows to apply certain rules (such as reducing or smoothing the rate, changing the order of packets, deleting a percentage of the packets) to the IP packets identified by a filter (such as a filter identifying all the packets intended to be transmitted by the network interface of the Wi-Fi station 30). Qdisc can be used to do Active Queue Management (AQM), which in this case would consist of pretending not to have received certain packets, which would reduce the rate of the stream if it is a TCP stream. TCP stream rate management systematically reduces the rate when the receiver has not received packets sent to it.

Another possible implementation would be to use the Explicit Congestion Notification (ECN) field of the IP headers of the packets. Placing the value 0b11 in this field in the packets sent by the set-top box 20 to the gateway 21 allows to indicate to the gateway 21 to reduce the rate.

Furthermore, a proprietary protocol could exist to communicate a maximum rate of the data transmission from the gateway 21 to the set-top box 20. However, that implementation would require a compatible gateway.

This list of implementations is not limiting but may include any other method allowing to limit the rate of data transfers between the set-top box 20 and the gateway 21.

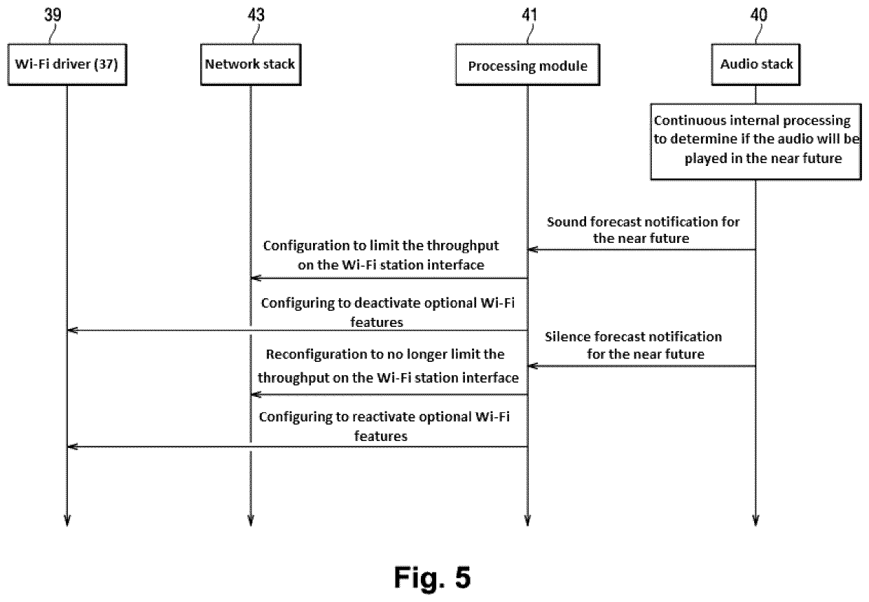

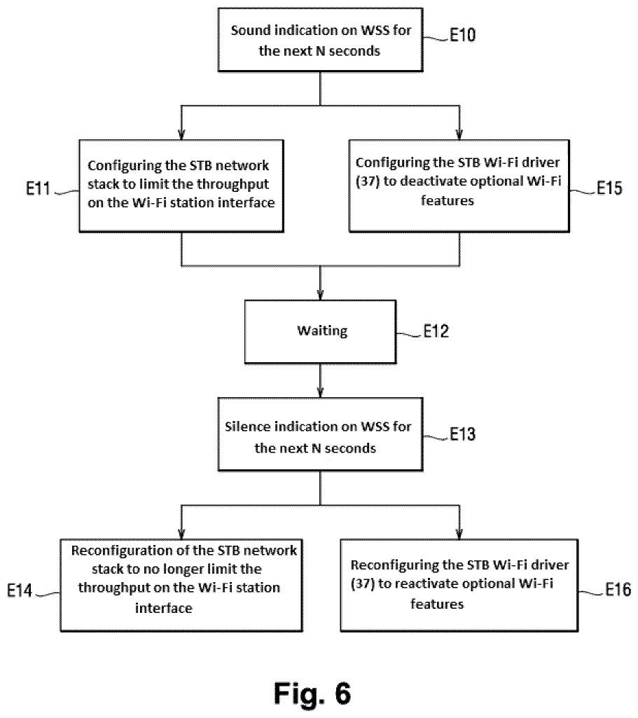

Thus, with reference to FIGS. 5 and 6, at time t, the audio stack 40 implements internal processing to check if audio will be played in the near future: step E10.

If the audio stack 40 has determined that the speakers 22 will emit sound in the near future, it notifies a software module, implemented in the processing module 41 and hereinafter referred to as a “rate limiter”. Upon receipt of this notification, the rate limiter configures the network stack 43 of the set-top box 20 to limit the transmission rate on the connection of the Wi-Fi station 30: step E11.

Then, the processing module 41 enters a waiting step: step E12.

This waiting step ends when the audio stack 40 determines that the speakers 22 will not emit sound in the near future. The audio stack 40 notifies the rate limiter: step E13.

Upon receipt of this notification, the rate limiter configures the network stack 43 of the set-top box 20 to undo the rate limitation made during step E11: step E14.

Thus, conversely, if the audio stack 40 detects that the speakers 22 will not playback sound in the near future, the audio stack 40 sends the silence forecast notification for the near future to the processing module 41. This commands a reconfiguration of the network stack 43 so as no longer to limit the rate on the Wi-Fi station interface 30.

In a third embodiment, said at least one limiting action, implemented by the processing unit 28 when the secondary access point will transmit an audio stream to the speakers 22 within the predetermined time, and therefore when the speakers 22 are about to playback sound, comprises an action consisting in blocking or deferring the implementation of at least one function not necessary for a connection of the station 30 to the first wireless network 32.

It should be noted that, once again, the predetermined time has a duration close to but greater than (or equal to) a duration of the function's performance.

Specifically, Wi-Fi stacks implement many features, some of which are necessary for communication, while others are optional, providing only auxiliary behaviors.

Some of these features, such as BSS Transition (often called steering) according to the IEEE 802.11v standard and Radio Measurements according to the IEEE 802.11k standard, are defined in IEEE 802.11 standards, while others, such as internal roaming, are not standardised but are widespread and present in many products.

These features may consist of scanning automatically, without consulting the scan management section of the Wi-Fi stack, as in the case of Radio Measurements and internal roaming. These features may also consist in automatically changing the configuration of the radio communication interface 27 (which requires cutting off the transmission in order to reset with the new configuration), which is the case of BSS Transition (i.e. one of the functions according to IEEE 802.11v).

Regarding the scan, unlike in the first embodiment, where the processing unit 28 filters the scan requests before blocking or deferring them, in this third embodiment, the processing unit 28 directly blocks or defers, without filtering, the optional scan functions.

There are therefore optional features that can at any time disrupt the transmission of data by the access point 31 of the set-top box 20, and therefore cause audio cuts on the speakers 22. This list of features is not limiting but may include any other optional Wi-Fi feature leading to the spontaneous cut of the data transmission by the Wi-Fi communication interfaces.

In order to prevent optional features from causing audio cuts to the satellite speakers 22 audible to the user, the processing unit 28 acts on the state of these features.

Thus, in reference again to FIGS. 5 and 6, the audio stack 40 therefore checks if the speakers 22 have emitted sound over several previous timeslots, and estimates that the same will be true for a next timeslot: E10.

If the audio stack 40 has determined that the speakers will emit sound in the near future, it notifies a software module of the processing module 41 hereinafter referred to as the “reconfigurator of the Wi-Fi stack”: step E15.

Upon receipt of this notification, the reconfigurator of the Wi-Fi stack configures the Wi-Fi driver 37 to block or defer each of the optional features, including internal roaming, BSS Transition, and Radio Measurements, that may cause data transmission cuts through the radio interface.

Then, the processing module 41 enters a waiting step: step E12.

This waiting step ends when the audio stack 40 determines that the speakers 22 will not emit sound in the near future. The audio stack 40 notifies the reconfigurator of the Wi-Fi stack: step E13.

Upon receipt of this notification, the reconfigurator configures the network stack 43 of the set-top box 20 to reactivate each of the optional features deactivated during step E15: step E16.

At the end of these steps, the optional Wi-Fi features cannot cause audible cuts to the audio emitted by the satellite speakers 22.

It should be noted that the implementation of the reconfiguration of the Wi-Fi stack 39 in order to deactivate and reactivate the features depends on the implementation of the Wi-Fi driver 37 itself, but generally consists in sending to the Wi-Fi driver 37 proprietary and supplier-specific commands for the Wi-Fi driver 37. The sending of commands can be done, for example, by sending netlink or ioctl messages which will then be transmitted to the Wi-Fi driver 37 by the operating system kernel of the set-top box 20.

Naturally, the invention is not limited to the embodiments described, but comprises any variant entering into the scope of the invention such as defined by the claims.

The processing unit could implement not one, but several limiting actions in a combined manner to limit the occupation of the communication channel by the first module.

The architecture of the processing unit, the set-top box and, more generally, the multimedia system, could be different from that described here.

The method used to determine that the speakers will not emit sound in the near future could be different from those described herein.

The playback equipment is not necessarily limited to speakers.

The media stream is not necessarily an audio stream, it could be, for example, a video stream.

1. A communication device comprising:
a radio communication interface comprising a first module arranged to use a communication channel within a first wireless network, and a second module arranged to use said communication channel within a second wireless network comprising at least one piece of playback equipment;
a processing unit arranged to determine, at a time t, whether the second module will transmit within a predetermined time following time t a media stream to said at least one piece of playback equipment of the second wireless network via said communication channel so that said at least one piece of playback equipment plays back said media stream and, if so, to implement at least one limiting action allowing to limit an occupation of said communication channel by the first module.

2. The communication device according to claim 1, wherein the stream media is an audio stream.

3. The communication device according to claim 1, wherein said at least one limiting action comprises an action consisting, following receipt of a scan request issued by an entity of an equipment integrating the communication device, in determining whether or not the scan associated with said scan request is necessary for a connection of the first module to the first wireless network, and in blocking or deferring the implementation of the scan only if the scan is not necessary for said connection.

4. The communication device according to claim 3, wherein the processing unit is arranged to determine whether or not the scan is necessary based on an identifier of said entity.

5. The communication device according to claim 1, wherein said at least one limiting action comprises an action consisting in blocking or deferring the implementation of at least one function not necessary for a connection of the first module to the first wireless network.

6. The communication device according to claim 3, wherein the predetermined time has a duration greater than or equal to a duration of performance of said scan or said at least one function.

7. The communication device according to claim 1, wherein said at least one limiting action comprises an action consisting in limiting a speed of a communication implemented by the first module.

8. The communication device according to claim 1, wherein the predetermined time following the time t is a timeslot of predefined duration, and wherein the processing unit detects that the second module will not transmit a media stream to said at least one piece of playback equipment in said timeslot following the time t when the second module has not transmitted a media stream to said at least one piece of playback equipment for a predetermined number of timeslots preceding the time t.

9. The communication device according to claim 1, wherein the first module is a Wi-Fi station, and the second module is a Wi-Fi access point.

10. A set-top box incorporating a communication device according to claim 1.

11. A communication method, implemented in the processing unit of a communication device according to claim 1, and comprising the steps of determining, at a time t, whether the second module will transmit within a predetermined time after the time t a media stream to the at least one piece of playback equipment of the second wireless network via the communication channel so that the at least one piece of playback equipment plays back the said media stream and, if so, implementing at least one limiting action allowing to limit occupation of the communication channel by the first module.

12. A computer program comprising instructions which cause the communication device according to claim 1 to execute the steps of a communication method comprising determining, at a time t, whether the second module will transmit within a predetermined time after the time t a media stream to the at least one piece of playback equipment of the second wireless network via the communication channel so that the at least one piece of playback equipment plays back the said media stream and, if so, implementing at least one limiting action allowing to limit occupation of the communication channel by the first module.

13. A non-transitory computer-readable storage medium on which the computer program according to claim 12 is stored.
